(19) United States
(12) Patent Application Publication
(10) Pub. No.: US 2026/0196935 A1
(43) Pub. Date: Jul. 9, 2026

(54) DEVICE AND METHOD FOR LIMITING A CURRENT

(71) Applicant: STMicroelectronics International N.V., Geneva (CH)

(72) Inventor: Karl GRANGE, Tours (FR)

(73) Assignee: STMicroelectronics International N.V., Geneva (CH)

(21) Appl. No.: 19/436,947

(22) Filed: Dec. 30, 2025

(30) Foreign Application Priority Data
Jan. 6, 2025 (FR) FR2500076

(51) Int. Cl. H02M 3/158; H02M 1/00

(52) U.S. Cl. CPC H02M 3/158; H02M 1/0009

(57) ABSTRACT

A device for limiting a current, includes a differential amplifier configured to equalize voltages across a power transistor and a sense transistor and a regulation circuit of an output current of the device for limiting a current. The regulation circuit includes a transconductance amplifier configured to limit the output current when an output electric potential of the differential amplifier is higher than or equal to a reference electric potential proportional to a reference current the value of which is equal to ILIMIT/(N.M), with ILIMIT corresponding to a current limit value, N corresponding to an aspect ratio between the power transistor and the sense transistor, and M corresponding to an aspect ratio between transistors of a current mirror coupled to the sense transistor.

### CROSS REFERENCE TO PRIORITY APPLICATION(S)

This application claims the priority benefit of French patent application number FR2500076, filed on January 6, 2025, entitled “Device and method for limiting a current”, which is hereby incorporated by reference to the maximum extent allowable by law.

### BACKGROUND

### Technical Field

The present disclosure relates generally to the field of current limitation. The present disclosure also relates to the field of protecting a circuit interface.

### Description of the Related Art

A device for limiting current, or current limiter, is an element generally present in circuits for protecting an interface. The optimal transfer characteristic, or function, of a current-limiting device, providing the value of the output voltage V_{OUT} of the device depending on the value of the output current I_{OUT} of the device, is illustrated in FIG. 1. According to this characteristic, such a device is configured to receive as input a voltage V_{IN}, and to output a voltage V_{OUT} equal to V_{IN} as long as the value of the output current I_{OUT} does not exceed a limit value I_{LIMIT} = V_{REF}/R_{REF}, with V_{REF} and R_{REF} respectively corresponding to a reference voltage and a reference resistive load. Beyond this current limit value, the device outputs a voltage having a zero value.

In a current-limiting device, a detection element is used to detect the value of the output current I_{OUT}, this detection element could correspond to an outer electric resistor. When place and cost constraints are to be considered, using an outer electric resistor is not appropriate. A MOSFET (“Metal Oxide Semiconductor Field Effect Transistor”) transistor configured as SenseFET (“Sense Field Effect Transistor”) is then possible. As a reminder, a SenseFET corresponds to a small-sized MOSFET closely matched with a power MOSGET, and configured to output a low current having a value proportional to that of the power current output by the power MOSFET.

Using such a SensFET has the advantage it does not call for an element external to the current-limiting device, does not add any dissipation element in the power path, and has a better accuracy in measurement than an integrated resistor.

However, issues appear in existing current-limiting devices using SenseFETs: instabilities, low bandwidth, exceeding the limit value I_{LIMIT}, too high power consumption, complexity of the devices, etc.

### BRIEF SUMMARY

One embodiment overcomes some or all the existing solutions and provides a device for limiting a current, including at least one:

differential amplifier configured to equalize voltages across a power transistor and a sense transistor, and inputs of which are coupled to a first conduction electrode of the power transistor, and to a first conduction electrode of the sense transistor; and

regulation circuit of an output current of the device for limiting a current, including at least one transconductance amplifier configured to limit the output current when an output electric potential of the differential amplifier is higher than or equal to a reference electric potential proportional to a reference current the value of which is equal to I_{LIMIT}/(N.M), with I_{LIMIT} corresponding to a current limit value, N corresponding to an aspect ratio between the power transistor and the sense transistor, and M corresponding to an aspect ratio between transistors of a current mirror coupled to the sense transistor.

According to a particular embodiment, the power transistor is a power MOSFET, and the sense transistor is a SenseFET.

According to a particular embodiment, the device further includes an input coupled to a second conduction electrode of the power transistor and to a second conduction electrode of the sense transistor, and on which an input current is intended to be applied, and an output coupled to the first conduction electrode of the power transistor, and on which the output current is intended to be supplied.

According to a particular embodiment, the power transistor is coupled to a non-inverting input of the differential amplifier, and the sense transistor is coupled to an inverting input of the differential amplifier.

According to a particular embodiment, the regulation circuit further includes a feedback transistor a gate of which is coupled to an output of the differential amplifier, a first conduction electrode of which is coupled to the sense transistor, and to one of the inputs of the differential amplifier, and a second conduction electrode of which is coupled to a first one of the transistors of the current mirror.

According to a particular embodiment, the sizes of the feedback transistor are identical to those of the first one of the transistors of the current mirror.

According to a particular embodiment, the regulation circuit further includes a transistor for balancing the current mirror, a gate of which is coupled as input to the transconductance amplifier, a first conduction electrode of which is coupled to a current source configured to supply the reference current, and a second conduction electrode of which is coupled to a second one of the transistors of the current mirror.

According to a particular embodiment, the sizes of the transistor for balancing the current mirror are identical to those of the second one of the transistors of the current mirror.

According to a particular embodiment, a non-inverting input of the transconductance amplifier is coupled to an output of the differential amplifier, and an inverting input of the transconductance amplifier is coupled to the gate of the transistor for balancing the current mirror.

According to a particular embodiment, the regulation circuit further includes a control circuit for controlling the power transistor and the sense transistor, including at least one output coupled to the gates of the power and sense transistors, and at least one input coupled to an output of the transconductance amplifier.

According to a particular embodiment, when the value of the output current is less than I_{LIMIT}, the value of the output electric potential of the differential amplifier is less than that of the reference electric potential and the transconductance amplifier is configured to supply in this case an output current having a zero value.

Another embodiment discloses a method for limiting a current, including at least:

amplifying a difference between an output current supplied by a power transistor and a sense current supplied by a sense transistor;

amplifying and converting into a current a difference between a first electric potential, having a value proportional to the difference between the output current and the sense current, and a reference electric potential proportional to a reference current the value of which is equal to I_{LIMIT}/(N.M), with I_{LIMIT} corresponding to a current limit value, N corresponding to an aspect ratio between the power transistor and the sense transistor, and M corresponding to an aspect ratio between transistors of a current mirror coupled to the sense transistor; and

limiting the value of the output current when the value of the first electric potential is higher than or equal to that of the reference electric potential.

According to a particular embodiment, when the value of the output current is less than I_{LIMIT}, the value of the first electric potential is then less than that of the reference electric potential, and the value of the output current is equal to that of an input current.

Another embodiment discloses a device for protecting an interface of an integrated circuit, including at least one device for limiting a current according to a particular embodiment.

Another embodiment proposes a method for protecting an interface of an integrated circuit, including at least implementing a method for limiting a current according to a particular embodiment.

### BRIEF DESCRIPTION OF THE SEVERAL VIEWS OF THE DRAWINGS

The foregoing features and advantages, as well as others, will be described in detail in the following description of specific embodiments given by way of illustration and not limitation with reference to the accompanying drawings, in which:

FIG. 1 illustrates an optimal transfer characteristic of a current-limiting device;

FIG. 2 schematically illustrates an example embodiment of a current-limiting device according to a specific embodiment;

FIG. 3 illustrates a transfer characteristic of a current-limiting device according to a specific embodiment;

FIG. 4, FIG. 5, and FIG. 6 schematically illustrate various operating mode of the current-limiting device shown in FIG. 2; and

FIG. 7 schematically illustrates a circuit provided with an interface-protecting device according to a specific embodiment.

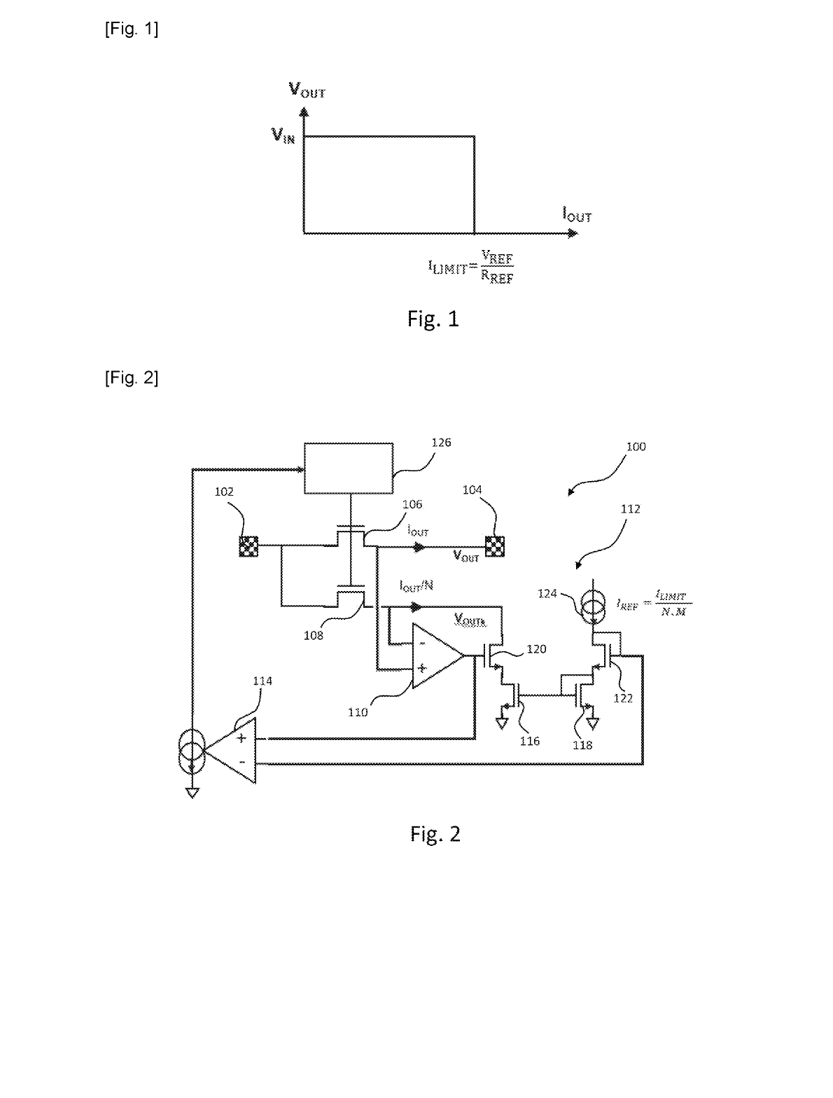

### DETAILED DESCRIPTION

Like features have been designated by like references in the various figures. In particular, the structural and/or functional features that are common among the various embodiments may have the same references and may dispose identical structural, dimensional and material properties. In the figures, so as to read them more easily, the various elements and the various material layers are not drawn to scale compared to each other.

For the sake of clarity, only the operations and elements that are useful for an understanding of the embodiments described herein have been illustrated and described in detail. In particular, various elements (differential amplifier, transconductance amplifier, switching-control circuit) are not described in detail. Those skilled in the art will be able to implement in detail these elements from the disclosure here exposed.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Further, the terms “coupled”, “linked”, or “connected” are herein used to refer to electric coupling, electric links, or electric connections.

In the following disclosure, unless indicated otherwise, when reference is made to absolute positional qualifiers, such as the terms “front”, “back”, ”top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures. However these terms do not assume actual location or orientation of the device during its use.

Unless specified otherwise, the expressions “around”, “approximately”, “substantially” and “in the order of” signify within 10%, and preferably within 5%.

Likewise, unless specified otherwise, the range of values include the ends of these ranges.

In all described embodiments, for each field effect transistor, the first and second conduction electrodes correspond to two electrodes different from each other of a same transistor, one corresponding to the source electrode and the other corresponding to the drain electrode.

One example embodiment of a current-limiting device 100 is hereinafter described in connection with FIG. 2.

In the example shown in FIG. 2, the device 100 includes an input 102 on which an input signal (voltage V_{IN} and current I_{IN}) is intended to be applied, and an output from which an output signal (voltage V_{OUT} and current I_{OUT}) is intended to be provided. Device 100 is intended to provide from output 104 the output voltage V_{OUT} equal to the input voltage V_{IN} as long as the value of the output current I_{OUT} is less than a limit value I_{LIMIT}.

Device 100 includes a power transistor 106 and a sense transistor 108. In the example embodiment described, the power transistor 106 is a power MOSFET, and the sense transistor 108 is a SenseFET. In the example embodiment described, the power MOSFET and the SenseFET are of the N-type. Alternatively, the power MOSFET and/or the SenseFET can be of the P-type.

The power transistor 106 and the sense transistor 108 are closely matched, i.e., the power transistor 106 here corresponds to N transistors 108 coupled in parallel one to the other, with N corresponding to an integer higher than 1.

Device 100 further includes a differential amplifier 110 particularly configured to equalize voltages across the power transistor 106 and across the sense transistor 108. Inputs of the differential amplifier 110 are coupled to a first conduction electrode of the power transistor 106, and to a first conduction electrode of the sense transistor 108. In the described example embodiment, the power transistor 106 and the sense transistor 108 are of the N-type, and the first conduction electrodes correspond to the sources of these transistors. More particularly, in the example shown in FIG. 2, the power transistor 106 is coupled to a non-inverting input of the differential amplifier 110, and the sense transistor 108 is coupled to an inverting input of the differential amplifier 110.

Further, in the example embodiment described, the input 102 is coupled to a second conduction electrode of the power transistor 106 and to a second conduction electrode of the sense transistor 108. In the example embodiment described, these second conduction electrodes correspond to drains of these transistors. The output 104 is coupled to the first conduction electrode of the power transistor 106.

Device 100 further includes a circuit 112 for regulating the output current I_{OUT}. These regulating circuit 112 includes at least one transconductance amplifier 114 configured to limit the output current I_{OUT} when an output electric potential of the differential amplifier 110 is higher than or equal to a reference electric potential being proportional to a reference current I_{REF} the value of which is equal to I_{LIMIT}/(N.M), with I_{LIMIT} corresponding to a current limit value the output current I_{OUT} should not exceed, N corresponding to an aspect in sizes between the power transistor 106 and the sense transistor 108 (or to the number of sense transistors 108 which are coupled in parallel one to the other to form the power transistor 106), and M corresponding to an aspect ratio between first and second transistors 116, 118 of a current mirror coupled to the sense transistor 108. M also corresponds to the number of second transistors 118 coupled in parallel one to the other to form the first transistor 116. In the example embodiment described, the first and second transistors 116, 118 of the current mirror are MOSFETs. As an example, the value of N could be of between 100 and 1000, and the value of M could be of between 1 and 10.

In the example embodiment described, the regulating circuit 112 further includes a feedback transistor 120, corresponding to a MOSFET in this example., a gate of which is coupled to an output of the differential amplifier 110. A first conduction electrode of the feedback transistor 120 is coupled to the sense transistor 108 (and more particularly to the first conduction electrode of the sense transistor 108 in the described example), and to one of the inputs of the differential amplifier 110 (corresponding to an inverting input of the differential amplifier 110). A second conduction electrode of the feedback transistor 120 is coupled to the first transistor 116 of the current mirror (to a first conduction electrode of the first transistor 116 in the example shown in FIG. 2). A second conduction electrode of the first transistor 116 is coupled to a reference electric potential, for example ground of device 100. In the example embodiment described, the sizes of the feedback transistor 120 are identical to those of the first transistor 116 of the current mirror.

In the example embodiment described, the regulating circuit 112 further includes a transistor 122, named current mirror balancing transistor, which enables to fulfill the balance condition of the current mirror formed by the first and second transistors 116, 118. The transistor 122 corresponds to a MOSFET in this example, a gate of which is coupled as input to the transconductance amplifier 114 (to the inverting input of the transconductance amplifier 114 in the example shown in FIG. 2). A first conduction electrode of the transistor 122 is coupled to a current source 124 configured to supply the reference current I_{REF}. A second conduction electrode of the transistor 122 is coupled to the second transistor 118 of the current mirror (more specifically a first conduction electrode of the second transistor 118 in the example shown in FIG. 2). A second conduction electrode of the second transistor 118 is coupled to the reference electric potential. In the example embodiment described, the sizes of the transistor 122 are identical to those of the second transistor 118 of the current mirror.

In the example embodiment described, a non-inverting input of the transconductance amplifier 114 is coupled to an output of the differential amplifier 110.

In the example shown in FIG. 2, the regulating circuit 112 further includes a control circuit 126 for controlling the power transistor 106 and the sense transistor 108 including at least one output coupled to the gates of the power 106 and sense 108 transistors, and at least one input coupled to an output of the transconductance amplifier 114. For example, the control circuit 126 can include a charge pump circuit. The control circuit 126 is configured to control the conduction state of the power transistor 106 and the sense transistor 108.

The power 106 and sense 108 transistors are closely matched with each other. During the operation of the device 100, the output current I_{OUT} and the output voltage V_{OUT} are output by the power transistor 106 on the output 104. A sense current supplied by the sense transistor 108 is equal to I_{OUT}/N, with N corresponding to the aspect ratio between the power transistor 106 and the sense transistor 108, i.e., the number of sense transistors 108 coupled in parallel to form the power transistor 106. To this end, the voltages across these transistors 106, 108 are kept equal to each other, i.e., with V_{OUT} = V_{OUTk}, by the differential amplifier 110, V_{OUTk} corresponding to the voltage across the sense transistor 108.

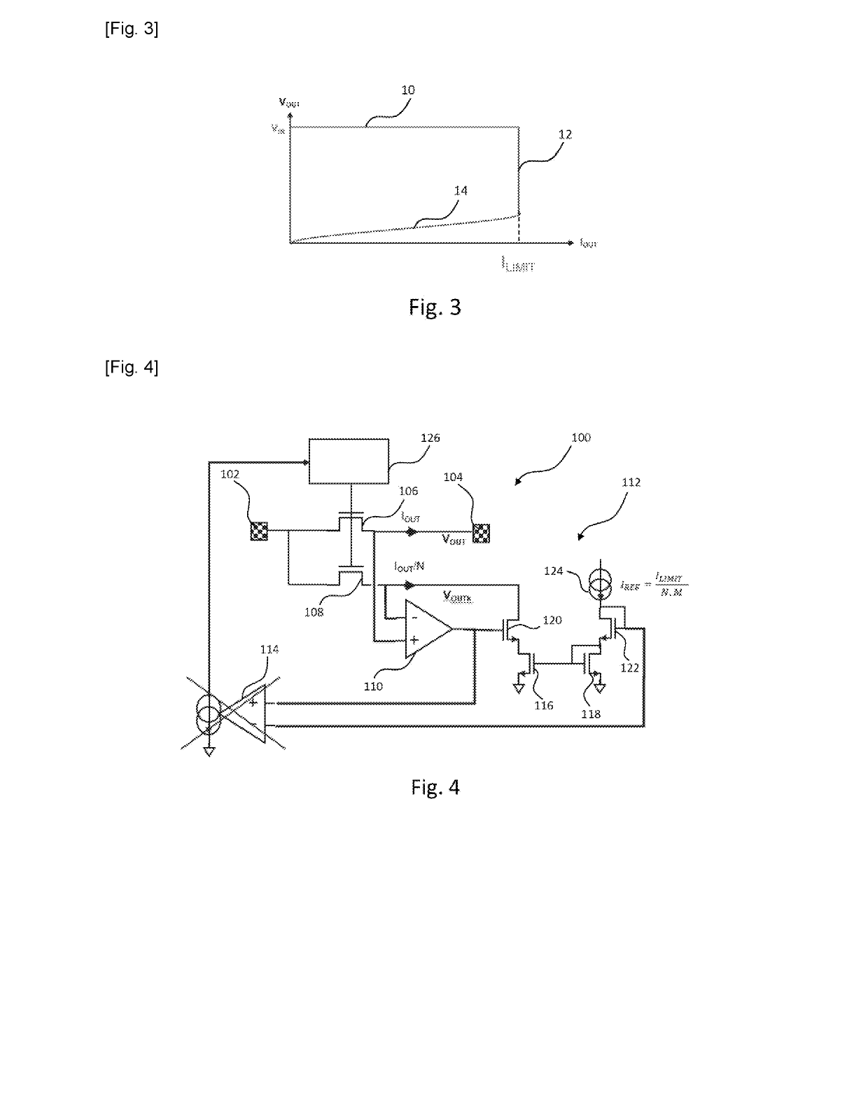

The transfer characteristic of device 100 is illustrated in FIG. 3.

In device 100, when the value of the output current I_{OUT} is less than the limit value I_{LIMIT}, the value of the current flowing through the feedback transistor 120 and the first transistor 116 of the current mirror is less than that flowing through the transistor 122 and the second transistor 118 of the current mirror. The value of the output electric potential of the differential amplifier 110 is thus less than that of the reference electric potential V_{REF} obtained on the gate of the transistor 122. This results in a current obtained as output of the transconductance amplifier 114 being null.

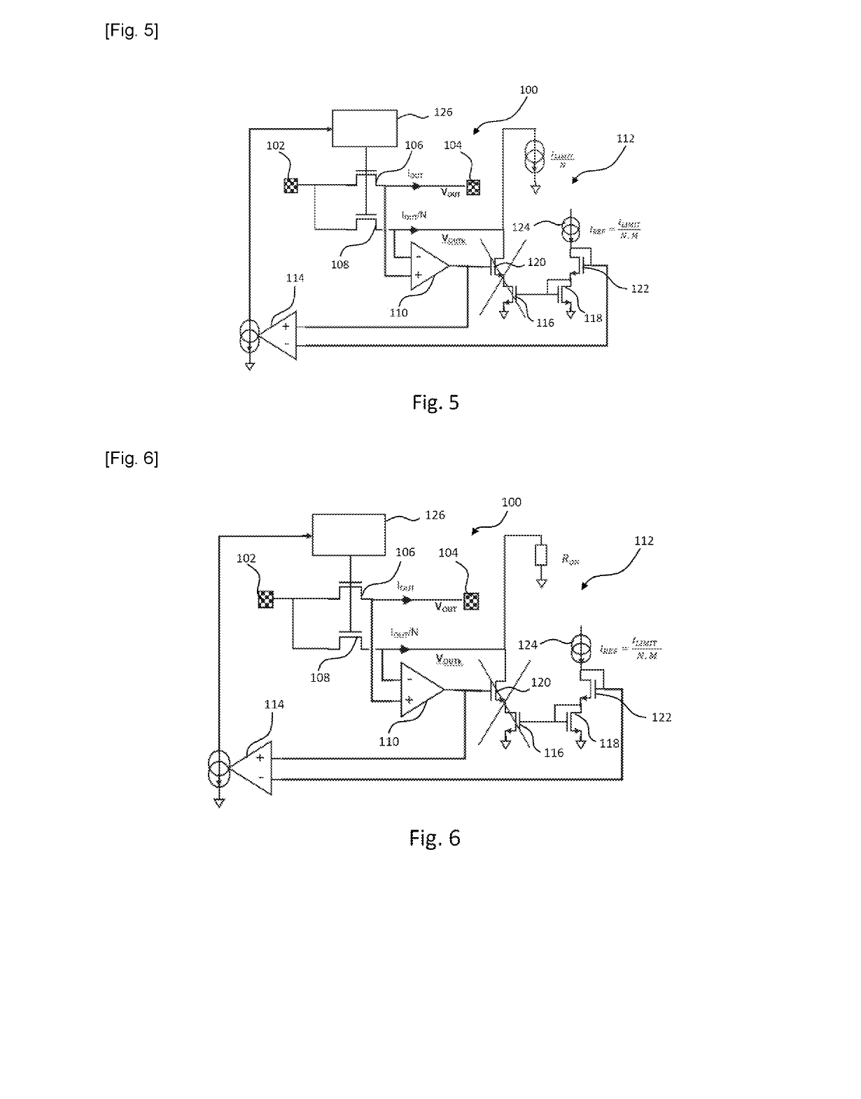

In this configuration, there is no limitation of the current output by the device 100. The current supplied by the power transistor 106 is not limited, and is entirely forwarded on the output 104. Such an operation of device 100 is similar to that of a pass gate, that would be coupled between the input 102 and the output 104. It corresponds to the part designated with the reference 10 of the characteristic illustrated in FIG. 3, on which the desired input voltage V_{IN} is seen, and with the current I_{OUT} < I_{LIMIT}. Further, FIG. 4 symbolically illustrates device 100 in such an operating mode, for example referred to as pass-gate mode, in which the transconductance amplifier 114 does not interfere in regulating the output current of device 100.

When the value of the output current I_{OUT} becomes equal to the limit value I_{LIMIT}, the value of the output electric potential of the differential amplifier 110 is then equal to that of the

reference electric potential V_{REF}. Transconductance amplifier 114 thus outputs a non-zero current, which via the control circuit 126, results in decreasing the control voltage applied on the gates of the power transistor 106 and of the sense transistor 108. In parallel, the first transistor 116 of the current mirror is in saturation state, which stops the regulation loop formed through the feedback transistor 120 and the first transistor 116 of the current mirror. These two transistors 116, 120 are thus equivalent to a current source supplying a current having a value equal to I_{LIMIT}/N.

In this configuration, the regulation of the current output by the device 100 is thus performed by the differential amplifier 110 and the transconductance amplifier 114 in series with each other. It corresponds to the part designated by reference 12 of the characteristic illustrated in FIG. 3, on which the value of the voltage V_{OUT} falls down, and with the value of the current I_{OUT} equal to the limit value I_{LIMIT}. Further, FIG. 5 symbolically illustrates the device 100 in such an operating mode, referred to as limitation mode, in which the feedback transistor 120 and the first transistor 116 of the current mirror could be seen as being replaced with a current source supplying a current equal to I_{LIMIT}/N.

When the value of the output electric potential of the differential amplifier 110 is equal to or higher than that of the reference electric potential V_{REF}, and V_{OUT} = V_{OUTk} < (V_{SAT120} + V_{SAT116}), with V_{SAT120} corresponding to the saturation voltage of the feedback transistor 120, and V_{SAT116} corresponding to the saturation voltage of the first transistor 116 of the current mirror, the feedback transistor 120 and the first transistor 116 of the current mirror are thus no more in saturation state, and operate in their linear or ohmic region. These two transistors 116, 120 are thus equivalent to a resistor R_{ON}, as symbolically illustrated in FIG. 6.

In this configuration, for example referred to as “fallback” mode or “foldback” mode, regulating the current output by device 100 is thus performed by differential amplifier 110 and transconductance amplifier 114 in series with each other. It corresponds to the part designated by reference 14 of the characteristic illustrated in FIG. 3, on which the value of the output voltage V_{OUT} keeps decreasing, and the value of the current I_{OUT} decreases as voltage V_{OUT} decreases and goes closer to 0.

Thus, is provided a device 100 for limiting a current based on a SenseFET, wherein the current consumed by device 100 is very low and equal to I_{REF} = I_{LIMIT}/(N.M).

Device 100 has a good stability because regulating the current is performed with only a single feedback loop. Indeed, triggering between the pass-gate mode and the limitation mode is herein obtained thanks to the saturation of the feedback transistor 120 and/or of the first transistor 116. Further, in device 100, the limitation and fallback modes are performed using the same components and that with a very reduced consumption.

Device 100 has a very reduced power consumption because the constant current requested to operate the device 100 is the reference current I_{REF} that may be close to 0.

Device 100 also has the advantage of being simple to implement, calls for few components, and has low static dissipation, i.e., a low power dissipated by the device 100 when I_{OUT} = 0, this power may be expressed by the equation:

P_{STATIC} = V₁₀₂.I_{LIMIT}/(N.M), with V₁₀₂ corresponding to the electric potential on the input 102.

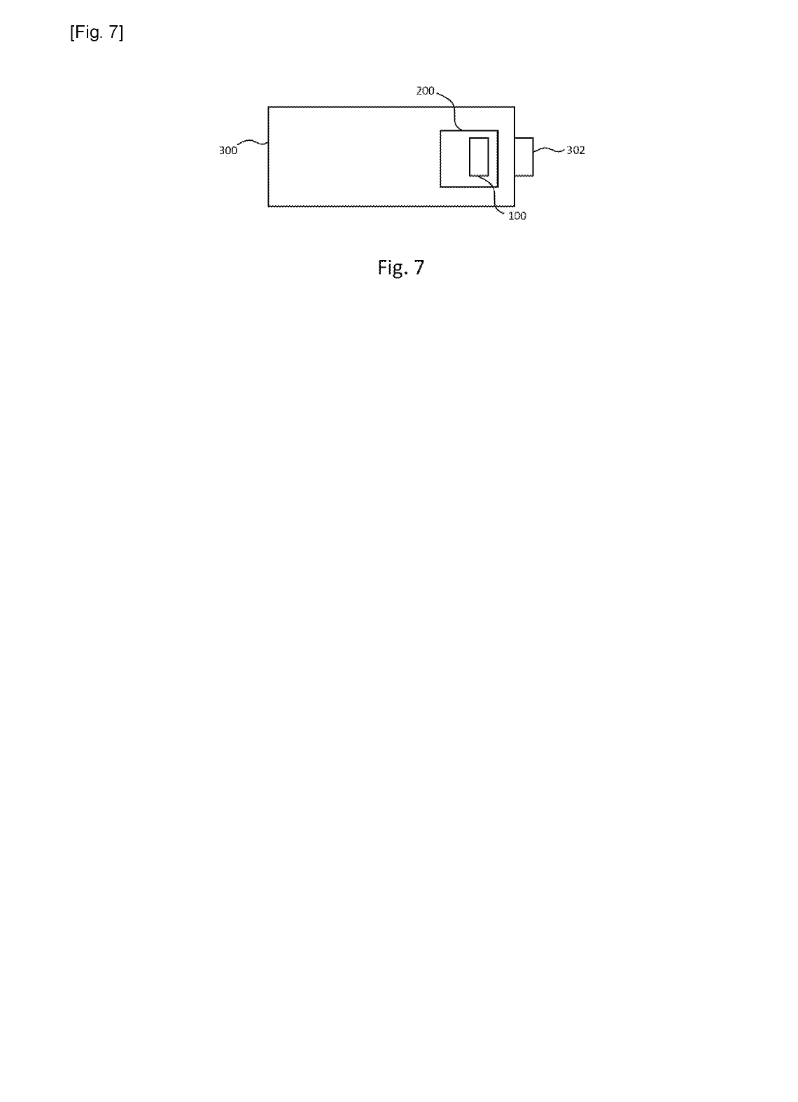

The device 100 for limiting the current is for example used in a device 200 for protecting an integrated circuit interface, symbolically illustrated in FIG. 7. In this figure, an integrated circuit 300 provided with an interface 302, for example of the USB-C type, includes the device 200, which in turn includes the device 100. The integrated circuit 300 is, for example, part of an electronic device such as, for example, a smart watch or any other wearable electronic connected device.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

A device (100) for limiting a current includes at least one: differential amplifier (110) configured to equalize voltages across a power transistor (106) and a sense transistor (108), and inputs of which are coupled to a first conduction electrode of the power transistor (106), and to a first conduction electrode of the sense transistor (108); and regulation circuit (112) of an output current of the device (100) for limiting a current, including at least one transconductance amplifier (114) configured to limit the output current when an output electric potential of the differential amplifier (110) is higher than or equal to a reference electric potential proportional to a reference current the value of which is equal to ILIMIT/(N.M), with ILIMIT corresponding to a current limit value, N corresponding to an aspect ratio between the power transistor (106) and the sense transistor (108), and M corresponding to an aspect ratio between transistors (116, 118) of a current mirror coupled to the sense transistor (108).

The power transistor (106) is a power MOSFET, and wherein the sense transistor (108) is a SenseFET.

The device (100) further includes an input (102) coupled to a second conduction electrode of the power transistor (106) and to a second conduction electrode of the sense transistor (108), and on which an input current is intended to be applied, and an output (104) coupled to the first conduction electrode of the power transistor (106), and on which the output current is intended to be supplied.

The power transistor (106) is coupled to a non-inverting input of the differential amplifier (110), and wherein the sense transistor (108) is coupled to an inverting input of the differential amplifier (110).

The regulation circuit (112) further includes a feedback transistor (120) a gate of which is coupled to an output of the differential amplifier (110), a first conduction electrode of which is coupled to the sense transistor (108), and to one of the inputs of the differential amplifier (110), and a second conduction electrode of which is coupled to a first one of the transistors (116) of the current mirror.

The sizes of the feedback transistor (120) are identical to those of the first one of the transistors (116) of the current mirror.

The regulation circuit (112) further includes a transistor (122) for balancing the current mirror, a gate of which is coupled as input to the transconductance amplifier (114), a first conduction electrode of which is coupled to a current source (124) configured to supply the reference current, and a second conduction electrode of which is coupled to a second one of the transistors (118) of the current mirror.

The sizes of the transistor (122) for balancing the current mirror are identical to those of the second one of the transistors (118) of the current mirror.

A non-inverting input of the transconductance amplifier (114) is coupled to an output of the differential amplifier (110), and wherein an inverting input of the transconductance amplifier (114) is coupled to the gate of the transistor (122) for balancing the current mirror.

The regulation circuit (112) further includes a control circuit (126) for controlling the power transistor (106) and the sense transistor (108) including at least one output coupled to the gates of the power (106) and sense (108) transistors, and at least one input coupled to an output of the transconductance amplifier (114).

When the value of the output current is less than ILIMIT, the value of the output electric potential of the differential amplifier (110) is less than that of the reference electric potential and the transconductance amplifier (114) is configured to supply in this case an output current having a zero value.

A method for limiting a current includes amplifying a difference between an output current supplied by a power transistor (106) and a sense current supplied by a sense transistor (108); amplifying and converting into a current a difference between a first electric potential, having a value proportional to the difference between the output current and the sense current, and a reference electric potential proportional to a reference current the value of which is equal to ILIMIT/(N.M), with ILIMIT corresponding to a current limit value, N corresponding to an aspect ratio between the power transistor (106) and the sense transistor (108), and M corresponding to an aspect ratio between transistors (116, 118) of a current mirror coupled to the sense transistor (108); and limiting the value of the output current when the value of the first electric potential is higher than or equal to that of the reference electric potential.

When the value of the output current is less than ILIMIT, the value of the first electric potential is then less than that of the reference electric potential, and the value of the output current is equal to that of an input current.

A device (200) for protecting an interface of an integrated circuit (300) includes at least one device (100) for limiting a current.

A method for protecting an interface of an integrated circuit (300) is summarized as including at least implementing a method for limiting a current.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for limiting a current, including at least one:
differential amplifier configured to equalize voltages across a power transistor and a sense transistor and including a first input coupled to a first conduction electrode of the power transistor and a second input coupled to a first conduction electrode of the sense transistor; and
regulation circuit of an output current of the device for limiting a current, including at least one transconductance amplifier configured to limit the output current when an output electric potential of the differential amplifier is higher than or equal to a reference electric potential proportional to a reference current having a value equal to ILIMIT/(N.M), with ILIMIT corresponding to a current limit value, N corresponding to an aspect ratio between the power transistor and the sense transistor, and M corresponding to an aspect ratio between transistors of a current mirror coupled to the sense transistor.

2. The device according to claim 1, wherein the power transistor is a power MOSFET, and wherein the sense transistor is a SenseFET.

3. The device according to claim 1, further comprising an input coupled to a second conduction electrode of the power transistor and to a second conduction electrode of the sense transistor and configured to receive an input current, and an output coupled to the first conduction electrode of the power transistor, and on which the output current is intended to be supplied.

4. The device according to claim 1, wherein the first input of the differential amplifier is a non-inverting input and the second input of the differential amplifier is an inverting input .

5. The device according to claim 1, wherein the regulation circuit further includes a feedback transistor having a gate coupled to an output of the differential amplifier, a first conduction electrode of coupled to the sense transistor and to one of the inputs of the differential amplifier, and a second conduction electrode coupled to a first one of the transistors of the current mirror.

6. The device according to claim 5, wherein the sizes of the feedback transistor are identical to those of the first one of the transistors of the current mirror.

7. The device according to claim 1, wherein the regulation circuit further includes a transistor for balancing the current mirror and including a gate coupled as an input to the transconductance amplifier, a first conduction electrode coupled to a current source configured to supply the reference current, and a second conduction electrode coupled to a second one of the transistors of the current mirror.

8. The device according to claim 7, wherein the sizes of the transistor for balancing the current mirror are identical to those of the second one of the transistors of the current mirror.

9. The device according to claim 7, wherein a non-inverting input of the transconductance amplifier is coupled to an output of the differential amplifier, and wherein an inverting input of the transconductance amplifier is coupled to the gate of the transistor for balancing the current mirror.

10. The device according to claim 1, wherein the regulation circuit further includes a control circuit for controlling the power transistor and the sense transistor and including at least one output coupled to the gates of the power and sense transistors and at least one input coupled to an output of the transconductance amplifier.

11. The device according to claim 1, wherein, when the value of the output current is less than ILIMIT, the value of the output electric potential of the differential amplifier is less than that of the reference electric potential, and the transconductance amplifier is configured to supply in this case an output current having a zero value.

12. A method for limiting a current, comprising at least:
amplifying a difference between an output current supplied by a power transistor and a sense current supplied by a sense transistor;
amplifying and converting into a current a difference between a first electric potential having a value proportional to the difference between the output current and the sense current and a reference electric potential proportional to a reference current having a value equal to ILIMIT/(N.M), with ILIMIT corresponding to a current limit value, N corresponding to an aspect ratio between the power transistor and the sense transistor, and M corresponding to an aspect ratio between transistors of a current mirror coupled to the sense transistor;
limiting the value of the output current when the value of the first electric potential is higher than or equal to that of the reference electric potential.

13. The method according to claim 12, wherein, when the value of the output current is less than ILIMIT, the value of the first electric potential is then less than that of the reference electric potential, and the value of the output current is equal to that of an input current.

14. The method of claim 12, further comprising protecting an interface of an integrated circuit.

15. The method of claim 12, wherein a first input of the differential amplifier is a non-inverting input and a second input of the differential amplifier is an inverting input .

16. The method of claim 12, wherein the regulation circuit further includes a feedback transistor having a gate coupled to an output of the differential amplifier, a first conduction electrode of coupled to the sense transistor and to one of the inputs of the differential amplifier, and a second conduction electrode coupled to a first one of the transistors of the current mirror.

17. The method of claim 16, wherein the sizes of the feedback transistor are identical to those of the first one of the transistors of the current mirror.

18. A device for protecting an interface of an integrated circuit, comprising:
a power transistor including a gate, a first conduction terminal, and a second conduction terminal configured to provide an output current;
a sensor transistor including a gate, a first conduction terminal, and a second conduction terminal coupled to the second conduction terminal of the power transistor;
a differential amplifier including a first input coupled to the first conduction terminal of the power transistor and a second input coupled to the first conduction terminal of the sense transistor;
a current mirror coupled to the first terminal of the sense transistor; and
a regulator circuit including a transconductance amplifier transconductance amplifier configured to limit the output current when an output electric potential of the differential amplifier is higher than or equal to a reference electric potential proportional to a reference current of the current mirror.

19. The device of claim 18, wherein the regulator circuit is configured to limit the output current when an output electric potential of the differential amplifier is higher than or equal to a reference electric potential proportional to a reference current having a value equal to ILIMIT/(N.M), with ILIMIT corresponding to a current limit value, N corresponding to an aspect ratio between the power transistor and the sense transistor, and M corresponding to an aspect ratio between transistors of the current mirror.

20. The device of claim 18, wherein the regulation circuit further includes a control circuit for controlling the power transistor and the sense transistor and including at least one output coupled to the gates of the power and sense transistors and at least one input coupled to an output of the transconductance amplifier.
